(19) United States
(12) Patent Application Publication
(10) Pub. No.: US 2026/0313239 A1
(43) Pub. Date: Oct. 8, 2026

(54) IMAGE PICKUP APPARATUS, CONTROL METHOD FOR IMAGE PICKUP APPARATUS, AND STORAGE MEDIUM

(71) Applicant: CANON KABUSHIKI KAISHA, Tokyo (JP)

(72) Inventor: SHUN KAWADA, Kanagawa (JP)

(21) Appl. No.: 19/330,202

(22) Filed: Sep. 16, 2025

(30) Foreign Application Priority Data
Oct. 7, 2024 (JP) 2024-176064

(51) Int. Cl. H04N 23/741; H04N 23/61; H04N 23/73; H04N 25/47

(52) U.S. Cl. CPC H04N 23/741; H04N 23/61; H04N 23/73; H04N 25/47

(57) ABSTRACT

A method capable of performing photographing with suppressed blurring of an object appearing from a region with a large contrast is provided. An image pickup apparatus includes an image pickup unit that outputs a frame-based image, a unit that extracts, from the frame-based image, a first region whose brightness is outside a dynamic range and a second region, a unit that obtains event signals, each of which indicates a position and a time, at which a change in luminance has occurred, in an angle of view, a unit that recognizes an object in the angle of view based on the event signals, a unit that calculates a movement vector of the object, a unit that calculates a photographing setting based on the movement vector, and a unit that reflects the photographing setting at a predetermined timing related to movement of the object from the first region to the second region.

### BACKGROUND

### Field of the Technology

The present disclosure relates to an image pickup apparatus, a control method for the image pickup apparatus, and a storage medium.

### Description of the Related Art

Conventionally, in an image pickup apparatus, a frame-based sensor, which photographs an image in synchronization with a synchronous signal such as a vertical synchronous signal, is used. In addition, in recent years, an image pickup apparatus that also uses an event-based sensor, which outputs a change in luminance of each pixel as an event signal, has also become known. Furthermore, a technique that combines a frame-based sensor and an event-based sensor has also been proposed. As a related technique, a technique disclosed in Japanese Laid-Open Patent Publication (kokai) No. 2020-161987 has been proposed. In the technique disclosed in Japanese Laid-Open Patent Publication (kokai) No. 2020-161987, a region of interest is determined based on event signals, and the control of a frame-based sensor is performed so that the region of interest is capable of being clearly photographed. As a result, it is possible to record the subject clearly even in an environment with a large contrast (with a large difference in brightness).

However, with the technique disclosed in Japanese Laid-Open Patent Publication (kokai) No. 2020-161987, although it is possible to clearly record the detected subject in a situation with a large difference in brightness, no consideration has been given to photographing that intentionally leaves unclear regions, such as a blocked-up shadow and a blown-out highlight, as a photographic expression. For this reason, it is difficult to perform photographing while suppressing blurring of, for example, a car appearing from a tunnel in a state of making the tunnel become a blocked-up shadow.

### SUMMARY

The present disclosure provides a method capable of performing photographing with suppressed blurring of an object appearing from a region with a large contrast while maintaining a preset exposure amount.

Accordingly, an aspect of the present disclosure provides an image pickup apparatus comprising an image pickup unit configured to output a frame-based image, and at least one processor and/or circuit configured to function as an extracting unit that extracts, from the frame-based image, a first region whose brightness is outside a dynamic range of the image pickup unit and a second region other than the first region, an obtaining unit that obtains event signals, each of which indicates a position and a time, at which a change in luminance has occurred, in an angle of view, at which the image pickup apparatus performs photographing, a recognizing unit that recognizes an object in the angle of view based on the event signals, a movement vector calculating unit that calculates a movement vector of the object, a photographing setting calculating unit that calculates a photographing setting of the image pickup unit based on the movement vector, and a unit that reflects the photographing setting at a predetermined timing related to movement of the object from the first region to the second region.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that schematically illustrates a configuration of an image pickup apparatus according to an embodiment of the present disclosure.

FIG. 2 is a flowchart that illustrates a procedure of a photographing control processing executed by the image pickup apparatus shown in FIG. 1.

FIG. 3 is a timing chart that illustrates the relationship between a frame-based image from a frame-based sensor included in the image pickup apparatus shown in FIG. 1, an event signal from an event-based sensor included in the image pickup apparatus shown in FIG. 1, and a mapping timing.

FIG. 4A, FIG. 4B, and FIG. 4C are diagrams that illustrate an example of photographing a scene with a large contrast by using the image pickup apparatus shown in FIG. 1.

FIG. 5 is a flowchart that illustrates another procedure of the photographing control processing executed by the image pickup apparatus shown in FIG. 1.

FIG. 6 is a flowchart that illustrates a procedure of an automatic photographing control processing executed by the image pickup apparatus shown in FIG. 1.

### DESCRIPTION OF THE EMBODIMENTS

The present disclosure will now be described in detail below with reference to the accompanying drawings showing embodiments thereof.

Hereinafter, an embodiment of the present disclosure will be described in detail with reference to the accompanying drawings.

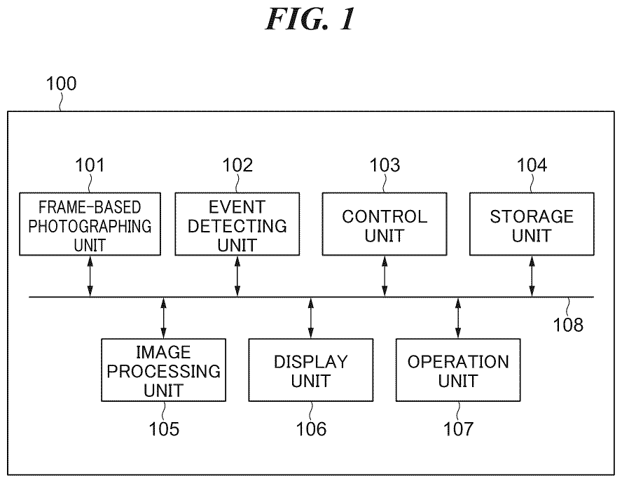

FIG. 1 is a block diagram that schematically illustrates a configuration of an image pickup apparatus 100 according to the embodiment of the present disclosure. As shown in FIG. 1, the image pickup apparatus 100 includes a frame-based photographing unit 101, an event detecting unit 102, a control unit 103, a storage unit 104, an image processing unit 105, a display unit 106, and an operation unit 107. The frame-based photographing unit 101, the event detecting unit 102, the control unit 103, the storage unit 104, the image processing unit 105, the display unit 106, and the operation unit 107 are connected to each other via a bus 108. The image pickup apparatus 100 is an apparatus capable of photographing frame-based images, such as a smartphone or a digital camera.

The frame-based photographing unit 101 includes a photographing optical system, a mechanical shutter, and an image pickup device (a frame-based sensor), all of which are not shown in FIG. 1. The photographing optical system includes an aperture, an image stabilization lens, a focus/zoom lens, etc., and guides an optical image of a subject to the frame-based sensor through the mechanical shutter. The mechanical shutter adjusts an exposure time for exposing the frame-based sensor. The frame-based sensor photoelectrically converts the optical image that has been formed by the lens, and outputs digital video image signals as an image based on frame (hereinafter, referred to as “a frame-based image”) to the image processing unit 105 and the storage unit 104. The frame-based image is outputted in synchronization with a synchronous signal such as a vertical synchronous signal so as to have a constant period. It should be noted that in the case where the frame-based sensor includes an electronic shutter function that is capable of adjusting the exposure time by controlling a signal accumulation time and a signal readout time, the mechanical shutter is not required.

The event detecting unit 102 includes a photographing optical system and an event-based sensor, all of which are not shown in FIG. 1. The event-based sensor included in the event detecting unit 102 outputs event signals, each of which indicates a position and a time, at which a change in luminance has occurred, in an angle of view, at which the image pickup apparatus 100 performs photographing. Specifically, the event-based sensor detects a change in the luminance of each pixel and outputs a position and a time of the pixel, at which the change in the luminance has occurred, as an event signal. The event signals to be outputted by the event detecting unit 102 are outputted asynchronously with the frame-based image to be outputted from the frame-based photographing unit 101 in synchronization with the synchronous signal such as the vertical synchronous signal. It should be noted that the photographing optical system of the event detecting unit 102 may be common to the photographing optical system of the frame-based photographing unit 101, or may be separate from the photographing optical system of the frame-based photographing unit 101.

The control unit 103 includes a central processing unit (a CPU), a program memory, etc., all of which are not shown in FIG. 1, and performs the control of the image pickup apparatus 100 by executing a predetermined program.

The storage unit 104 is a volatile memory that allows stored data to be rewritten, and stores the frame-based image that has been received from the frame-based photographing unit 101 and data that has been received from the image processing unit 105.

The image processing unit 105 includes a graphics processing unit (a GPU), a program memory, etc., all of which are not shown in FIG. 1, and mainly performs calculation processing of an image or the like by executing a predetermined program.

The display unit 106 includes a display such as a liquid crystal panel or an organic EL display, and displays images obtained from the image processing unit 105 and the storage unit 104.

The operation unit 107 includes buttons, sensors, etc., all of which are not shown in FIG. 1, and is a user interface that is operated by a user. It should be noted that in the present embodiment, a configuration may be adopted in which the image pickup apparatus 100 communicates with an external information processing apparatus, and the image pickup apparatus 100 is capable of being operated from the external information processing apparatus by using software that has been installed into the image pickup apparatus 100.

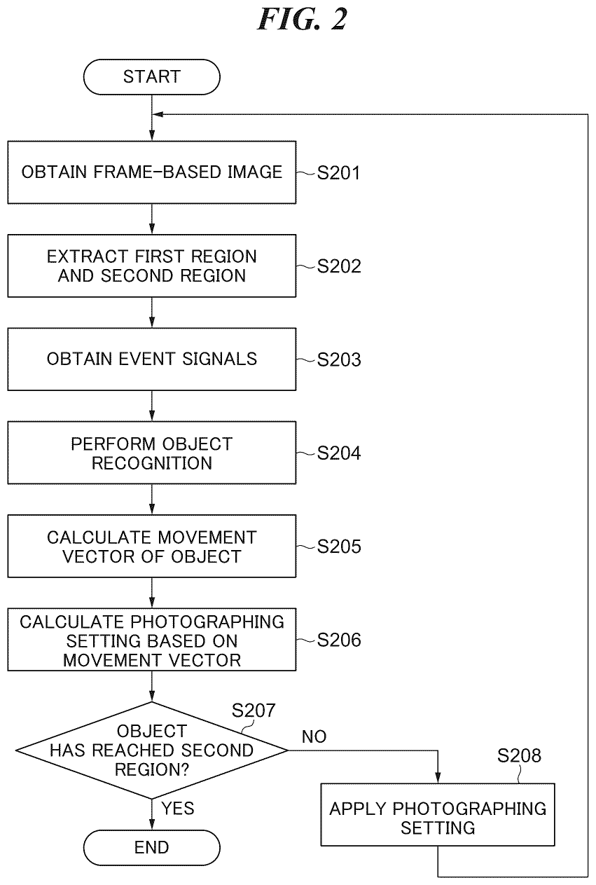

FIG. 2 is a flowchart that illustrates a procedure of a photographing control processing executed by the image pickup apparatus 100 shown in FIG. 1. The photographing control processing of FIG. 2 is realized by the CPU of the control unit 103 executing a program that has been stored in the program memory of the control unit 103. The photographing control processing of FIG. 2 is started, for example, when the user has performed a predetermined operation via the operation unit 107 or when the image pickup apparatus 100 is started up.

As shown in FIG. 2, first, in S201, the control unit 103 controls the frame-based photographing unit 101 to obtain a frame-based image. The frame-based photographing unit 101 outputs the obtained frame-based image to the image processing unit 105.

Next, in S202, the control unit 103 controls the image processing unit 105 to extract a first region and a second region from the obtained frame-based image. The first region is a region in the frame-based image whose brightness is outside a dynamic range of the frame-based sensor, such as a blocked-up shadow region or a blown-out highlight region, and the second region is a region in the frame-based image other than the first region. The first region and the second region are determined based on pixel values of the frame-based image. For example, luminance values are obtained (calculated) based on the pixel values of the frame-based image, and a region composed of pixels with the luminance values equal to or less than a first threshold value for extracting the blocked-up shadow region is set as the first region, and a region composed of pixels with the luminance values higher than the first threshold value is set as the second region. In addition, a region composed of pixels with the luminance values equal to or greater than a second threshold value for extracting the blown-out highlight region is set as the first region, and a region composed of pixels with the luminance values lower than the second threshold value is set as the second region. It should be noted that in the present embodiment, the threshold values to be used in S202 may be determined based on an instruction from the user, the result of image analysis of the frame-based image, or the like. Based on this determination, in S202, the first region and the second region are extracted by using only the first threshold value or only the second threshold value, alternatively, the first region and the second region are extracted by using both the first threshold value and the second threshold value.

Next, in S203, the control unit 103 controls the event detecting unit 102 to output, to the image processing unit 105, the event signals including information about the positions and the times of the luminance changes that have been detected by the event-based sensor.

Next, in S204, the control unit 103 controls the image processing unit 105 to perform object recognition. Specifically, the image processing unit 105 maps the positions of the luminance changes indicated by the event signals that have been outputted in S203 as two-dimensional data for each predetermined period. Here, the predetermined period is, for example, a period of 1/10 frame with respect to the frame-based image. The image processing unit 105 performs the object recognition by using this two-dimensional data. In the object recognition, for example, in the case where a mass of the mapped positions has a predetermined area or more, the mass is recognized as an object. It should be noted that the region that has been mapped as the two-dimensional data corresponds to the angle of view of the frame-based image.

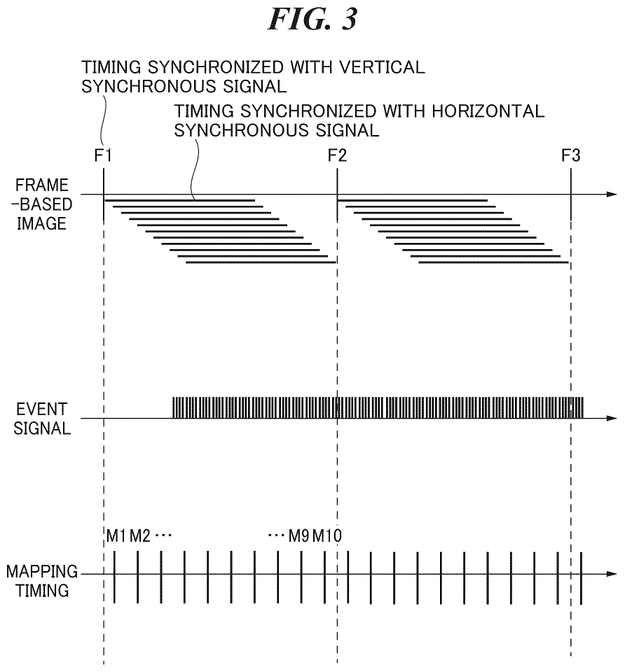

Next, in S205, the control unit 103 controls the image processing unit 105 to calculate a movement vector based on a change in the position of the object that has been recognized in S204. The movement vector is, for example, a change in the center position of the object. Here, since the mapping of the two-dimensional data is performed for every 1/10 frame, the movement vector is calculated ten times for one frame-based image. The image processing unit 105 transmits, to the control unit 103, information about the movement vector of the recognized object during an exposure period of one frame. It should be noted that the image processing unit 105 may transmit, to the control unit 103, information about the movement vector for each mapping of the recognized object, respectively. Here, the relationship between the frame-based image, the event signal, and a mapping timing will be described with reference to FIG. 3.

FIG. 3 is a timing chart that illustrates the relationship between the frame-based image from the frame-based sensor included in the image pickup apparatus 100 shown in FIG. 1, the event signal from the event-based sensor included in the image pickup apparatus 100 shown in FIG. 1, and the mapping timing.

In FIG. 3, with respect to a frame-based image, at F1, which is a timing synchronized with the frame synchronous signal, the processing operation of the first frame (hereinafter, referred to as “an F1 frame”) is started, and exposure and data output are performed sequentially at timings synchronized with the horizontal synchronous signal. As the processing of the next frame, the processing operation of the second frame from F2 (hereinafter, referred to as “an F2 frame”) is started. In addition, in the case where the mapping of the two-dimensional data based on the event signals by the image processing unit 105 is performed for every 1/10 frame as described above, for example, the mapping processing of 10 times from M1 to M10 are performed during the F1 frame. The position of the recognized object in the frame-based image of the F2 frame is calculated based on the movement vector from M1 to M10 of the recognized object. As described above, since the region that has been mapped as the two-dimensional data corresponds to the angle of view of the frame-based image, it becomes possible to calculate the position in the frame-based image to which the object that has been recognized based on the event signals has moved. It should be noted that the number of times of the mapping during one frame does not have to be ten.

Returning to FIG. 2, in S206, the control unit 103 calculates a photographing setting for the frame-based image based on the movement vector that has been calculated in S205. Here, the current shutter speed is assumed to be SS0. It is possible to obtain (calculate) a shutter speed SS1, at which an object is capable of being photographed without subject blurring, by using a length L of the movement vector that has been calculated in S205 and a mapping interval tm, based on the following Expression 1.

$$SS 1 = tm / L \qquad [ Expression 1 ]$$

Here, a change in exposure that occurs when the current shutter speed SS0has been changed to the shutter speed SS1 that has been calculated based on Expression 1 is assumed to be ΔSS. Either an ISO sensitivity or an aperture stopping amount, or both the ISO sensitivity and the aperture stopping amount are changed so as to cancel out the change in exposure ΔSS. The relationship between the settings at this time is capable of being expressed by the following Expression 2, where a change in the ISO sensitivity is ΔISO and a change in the aperture stopping amount is ΔAv.

$$Δ SS + Δ ISO + Δ av = 0 \qquad [ Expression 2 ]$$

In Expression 2, a unit of each variable represents the number of steps (an exposure value, i.e., an EV) of the exposure change (the change in exposure). For example, in the case where the shutter speed is decreased by one step (1EV), the ISO sensitivity is increased by one step (1EV). In the case where the ISO sensitivity alone is not capable of compensating, both the ISO sensitivity and the aperture stopping amount are adjusted so that Expression 2 holds. For example, in the case where the shutter speed is decreased by one step (1EV), the ISO sensitivity is increased by ⅔ step (⅔EV), and the aperture stopping amount is increased by ⅓ step (⅓EV). By performing the control in this way, it is possible to obtain a photographing setting, with which a moving object is capable of being photographed without subject blurring while maintaining the amount of exposure (an exposure amount) intended by the user. It should be noted that by performing the control to adjust the ISO sensitivity with priority over the aperture stopping amount among the ISO sensitivity and the aperture stopping amount, it is possible to make it difficult for a change in the depth of field to occur. In addition, by performing the control to adjust the aperture stopping amount with priority over the ISO sensitivity among the ISO sensitivity and the aperture stopping amount, it is possible to suppress a change in image quality due to the change in the ISO sensitivity. In the present embodiment, either the ISO sensitivity or the aperture stopping amount may be adjusted with priority.

Next, in S207, the control unit 103 determines whether or not the object that has been recognized in S204 has moved from the first region and has reached the second region. In the case of being determined that the object that has been recognized in S204 has moved from the first region and has reached the second region (YES in S207), the photographing control processing of FIG. 2 ends. On the other hand, in other cases (NO in S207), the photographing control processing of FIG. 2 proceeds to S208.

In S208, the control unit 103 applies the photographing setting that has been calculated in S206 to the frame-based photographing unit 101. In this way, in the present embodiment, the photographing setting that has been calculated in S206 is applied to the frame-based photographing unit 101 at a timing before the object that has been recognized in S204 moves from the first region and reaches the second region. As a result, for example, when the object that has been recognized in S204 has appeared from the blocked-up shadow region into a visible region (the second region), a photographing setting, with which the object that has been recognized in S204 is capable of being photographed without subject blurring, has already been reflected in the image pickup apparatus 100. Thereafter, the photographing control processing of FIG. 2 returns to S201. When the photographing control processing of FIG. 2 that has been described above is completed, for example, the image pickup apparatus 100 performs automatic photographing of a predetermined number of images without receiving any operation from the user.

According to the above-described embodiment, the first region whose brightness is outside the dynamic range of the frame-based sensor of the frame-based photographing unit 101, and the second region other than the first region are extracted from the frame-based image. In addition, the object recognition is performed based on the event signals that have been outputted from the event-based sensor of the event detecting unit 102, and the photographing setting of the frame-based sensor is calculated based on the movement vector of the recognized object. Here, the movement vector is obtained by using the event-based sensor, which has a wider dynamic range than the frame-based sensor. Therefore, even in a state of not capable of detecting an object from the frame-based image that has been outputted by the frame-based sensor based on a preset exposure amount, it is possible to calculate a photographing setting, with which photographing is capable of being performed while suppressing blurring of the object based on the movement vector that has been calculated by the event-based sensor. As a result, it is possible to perform photographing with suppressed blurring of the object appearing from a region with a large contrast (with a large difference in brightness) while maintaining the preset exposure amount. In addition, the user does not need to perform an operation to change the photographing setting in accordance with the movement of the object, and is able to concentrate solely on the timing of the shutter.

In addition, in the above-described embodiment, the timing at which the photographing setting is reflected is the timing before the object reaches the second region. As a result, when the object has reached the second region, it is possible to perform photographing with suppressed blurring of the object while maintaining the preset exposure amount.

In addition, in the above-described embodiment, the region composed of the pixels with the luminance values equal to or less than the first threshold value for extracting the blocked-up shadow region is set as the first region, and the region composed of the pixels with the luminance values higher than the first threshold value is set as the second region. As a result, it is possible to perform photographing with suppressed blurring of the object appearing from the blocked-up shadow region while maintaining an exposure amount that has been set in advance by the user.

In addition, in the above-described embodiment, the region composed of the pixels with the luminance values equal to or greater than the second threshold value for extracting the blown-out highlight region is set as the first region, and the region composed of the pixels with the luminance values lower than the second threshold value is set as the second region. As a result, it is possible to perform photographing with suppressed blurring of the object appearing from the blown-out highlight region while maintaining the exposure amount that has been set in advance by the user.

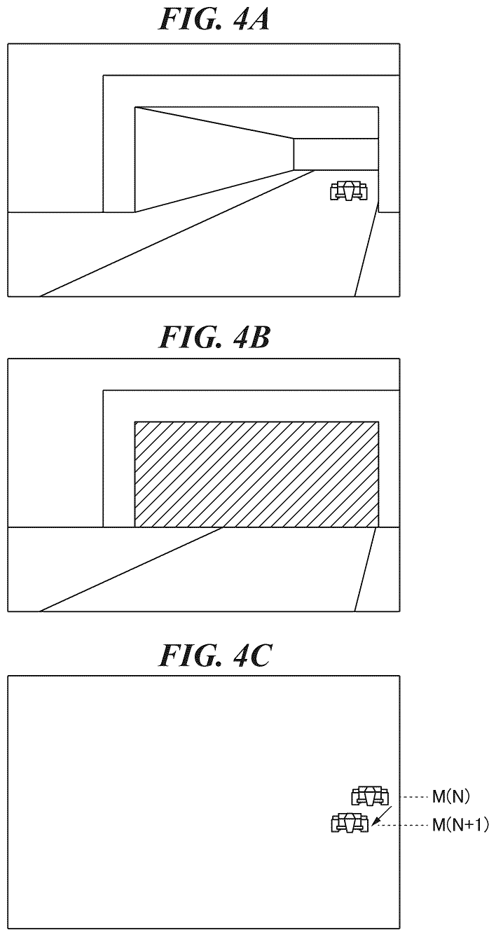

FIG. 4A, FIG. 4B, and FIG. 4C are diagrams that illustrate an example of photographing a scene with a large contrast (with a large difference in brightness) by using the image pickup apparatus 100 shown in FIG. 1.

FIG. 4A is a diagram that illustrates the angle of view of the image pickup apparatus 100. FIG. 4A shows one example of the scene with a large difference in brightness, in which a car that is the object is moving from the depth to the front near the exit of a tunnel.

FIG. 4B is a diagram that shows one example of the frame-based image in a state where the user has determined the angle of view and the exposure amount and is waiting for the subject to appear from the tunnel. Since the exposure is adjusted to the outside of the tunnel, the inside of the tunnel becomes a blocked-up shadow and is not capable of being seen. In this state, the object inside the tunnel is not capable of being seen, making it difficult to perform a photographing setting suitable for the object coming out of the tunnel.

FIG. 4C is a diagram that shows an object that has been recognized by the event detecting unit 102. A movement vector is calculated based on the position of the object at a time point of mapping M(N) and the position of the object at a time point of mapping M(N+1).

First, the user sets the angle of view and the exposure amount in accordance with an image (an impression) of the photographing result as shown in FIG. 4B by using a video image obtained from the frame-based sensor. Thereafter, even in the case where the object is in a region that is not capable of being confirmed by the frame-based sensor of the image pickup apparatus 100 due to becoming a blocked-up shadow, the event-based sensor is capable of recognizing the subject and obtaining the movement vector. When the movement vector is calculated, before the object that has been recognized by the event-based sensor becomes visible (before the object that has been recognized by the event-based sensor reaches the visible region), the image pickup apparatus 100 applies, to the frame-based sensor, a photographing setting that prevents subject blurring while maintaining the exposure amount intended by the user. As a result, the user is able to perform photographing with an appropriate photographing setting from the moment the object comes into view.

It should be noted that although FIG. 4A, FIG. 4B, and FIG. 4C have illustrated an example of a situation in which the object appears from the blocked-up shadow region within the field of view, also in a situation in which the object appears from the blown-out highlight region within the field of view, similar control is performed.

As in the photographing control processing of FIG. 2 that has been described above, the configuration, in which the photographing setting that has been calculated in S205 is reflected before the object that has been recognized in S204 moves from the first region and reaches the second region, has the advantage that the setting of the frame-based sensor is always adjusted to match the subject. However, since the photographing setting is changed each time a frame-based image is obtained, the processing load for changing the photographing setting will increase, and the image quality of a live view video image obtained by the frame-based sensor will change each time.

In order to deal with this issue, in the present embodiment, the photographing setting is reflected at a timing when the object that has moved from the first region has reached the second region.

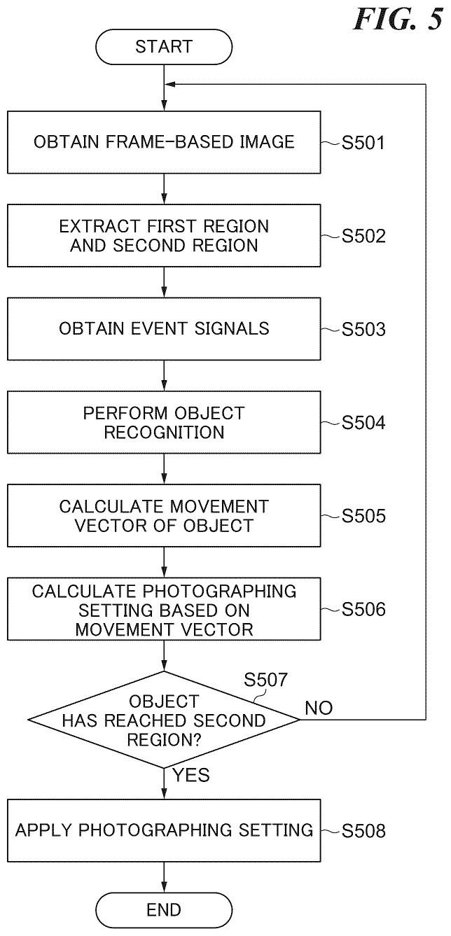

FIG. 5 is a flowchart that illustrates another procedure of the photographing control processing executed by the image pickup apparatus 100 shown in FIG. 1. It should be noted that the photographing control processing of FIG. 5 is similar to the photographing control processing of FIG. 2, which has been described above, and the following will particularly describe the differences from the photographing control processing of FIG. 2, which has been described above. Similar to the photographing control processing of FIG. 2 that has been described above, the photographing control processing of FIG. 5 is also realized by the CPU of the control unit 103 executing a program that has been stored in the program memory of the control unit 103. In addition, similar to the photographing control processing of FIG. 2 that has been described above, the photographing control processing of FIG. 5 is also started, for example, when the user has performed a predetermined operation via the operation unit 107 or when the image pickup apparatus 100 is started up.

As shown in FIG. 5, first, processes of S501 to S506, which are the same as the processes of S201 to S206 that have been described above, are performed.

Next, in S507, the control unit 103 determines whether or not the object that has been recognized in S504 has moved from the first region and has reached the second region. In the case of being determined that the object that has been recognized in S504 has moved from the first region and has reached the second region (YES in S507), the photographing control processing of FIG. 5 proceeds to S508. On the other hand, in other cases (NO in S507), the photographing control processing of FIG. 5 returns to S501.

In S508, the control unit 103 applies the photographing setting that has been calculated in S506 to the frame-based photographing unit 101. After that, the photographing control processing of FIG. 5 ends. When the photographing control processing of FIG. 5 that has been described above is completed, for example, the image pickup apparatus 100 performs automatic photographing of a predetermined number of images without receiving any operation from the user.

In the photographing control processing of FIG. 5 that has been described above, the timing at which the photographing setting is reflected is the timing when the object that has moved from the first region has reached the second region. As a result, it is possible to keep the frequency of changing the photographing setting to a required minimum. As a result, it is possible to reduce the processing load for changing the photographing setting, and it is also possible to stabilize the image quality of the live view video image.

In the above-described embodiments, the configuration, in which the automatic photographing is performed after the photographing control processing of FIG. 2 or the photographing control processing of FIG. 5 has been completed, has been described, but the present disclosure is not limited to this configuration. For example, the image pickup apparatus 100 may perform photographing at a timing when a predetermined operation serving as a photographing instruction is received from the user during the automatic photographing. The predetermined operation is, for example, a press-down operation of a shutter button (not shown) of the image pickup apparatus 100. The image that has been obtained in accordance with the operation that has been received from the user in this way is an image at a timing intended by the user. It is preferable that such an image is made to be distinguishable from other images that have been obtained by the automatic photographing so that the user is able to easily perform the management of the images.

In order to deal with this issue, in the present embodiment, information serving as a mark is added to a frame-based image that has been obtained at the timing when the predetermined operation is received from the user during the automatic photographing.

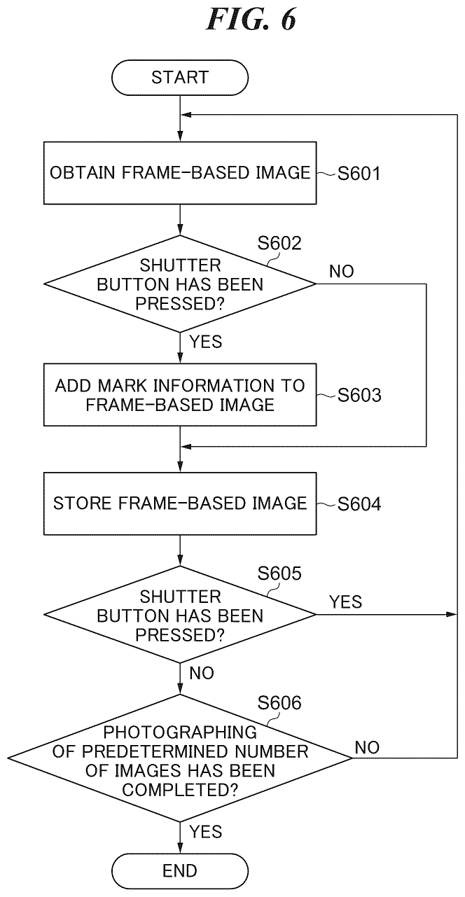

FIG. 6 is a flowchart that illustrates a procedure of an automatic photographing control processing executed by the image pickup apparatus 100 shown in FIG. 1. The automatic photographing control processing of FIG. 6 is realized by the CPU of the control unit 103 executing a program that has been stored in the program memory of the control unit 103. In addition, the automatic photographing control processing of FIG. 6 is executed after the photographing control processing of FIG. 2, which has been described, or the photographing control processing of FIG. 5, which has been described, has been completed.

As shown in FIG. 6, first, in S601, the control unit 103 controls the frame-based photographing unit 101 to obtain a frame-based image. The frame-based photographing unit 101 outputs the obtained frame-based image to the image processing unit 105. It should be noted that at this time, the photographing setting that has been applied to the frame-based photographing unit 101 is the photographing setting that has been applied in S208 or the photographing setting that has been applied in S508.

Next, in S602, the control unit 103 determines whether or not the shutter button has been pressed by the user. In the case of being determined that the shutter button has not been pressed by the user (NO in S602), the automatic photographing control processing of FIG. 6 proceeds to S604, which will be described below. On the other hand, in the case of being determined that the shutter button has been pressed by the user (YES in S602), the automatic photographing control processing of FIG. 6 proceeds to S603.

In S603, the control unit 103 adds information serving as a mark to the frame-based image that has been obtained in S601. The information serving as a mark is a tag or the like that has a property capable of distinguishing the presence or absence of an operation from the user.

Next, in S604, the control unit 103 stores, in the storage unit 104, the frame-based image that has been obtained in S601. In addition, the control unit 103 counts up the number of photographed images that have been stored.

Next, in S605, the control unit 103 determines whether or not the shutter button has been pressed by the user. In the case of being determined that the shutter button has been pressed by the user (YES in S605), the automatic photographing control processing of FIG. 6 returns to S601. On the other hand, in the case of being determined that the shutter button has not been pressed by the user (NO in S605), the automatic photographing control processing of FIG. 6 proceeds to S606.

In S606, the control unit 103, based on the number of photographed images that has been counted up in S604, determines whether or not photographing of a predetermined number of images has been completed. In the case of being determined that the photographing of the predetermined number of images has not been completed (NO in S606), the automatic photographing control processing of FIG. 6 returns to S601. On the other hand, in the case of being determined that the photographing of the predetermined number of images has been completed (YES in S606), the automatic photographing control processing of FIG. 6 ends.

In the automatic photographing control processing of FIG. 6 that has been described, the information serving as a mark is added to the frame-based image that has been obtained at the timing when the predetermined operation is received from the user during the automatic photographing. As a result, the user is able to easily identify an image at a desired timing from among a plurality of images that have been obtained by photographing.

According to the present disclosure, it is possible to perform photographing with suppressed blurring of the object appearing from a region with a large contrast (with a large difference in brightness) while maintaining the preset exposure amount.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-176064, filed Oct. 7, 2024, which is hereby incorporated by reference herein in its entirety.

What is claimed is:

1. An image pickup apparatus comprising:
an image pickup unit configured to output a frame-based image; and
at least one processor and/or circuit configured to function as:
an extracting unit that extracts, from the frame-based image, a first region whose brightness is outside a dynamic range of the image pickup unit and a second region other than the first region;
an obtaining unit that obtains event signals, each of which indicates a position and a time, at which a change in luminance has occurred, in an angle of view, at which the image pickup apparatus performs photographing;
a recognizing unit that recognizes an object in the angle of view based on the event signals;
a movement vector calculating unit that calculates a movement vector of the object;
a photographing setting calculating unit that calculates a photographing setting of the image pickup unit based on the movement vector; and
a unit that reflects the photographing setting at a predetermined timing related to movement of the object from the first region to the second region.

2. The image pickup apparatus according to claim 1, wherein
the predetermined timing is a timing before the object reaches the second region.

3. The image pickup apparatus according to claim 1, wherein
the predetermined timing is a timing when the object that has moved from the first region has reached the second region.

4. The image pickup apparatus according to claim 2, wherein
after the object that has moved from the first region has reached the second region, photographing of the object is performed based on the reflected photographing setting.

5. The image pickup apparatus according to claim 3, wherein
after the object that has moved from the first region has reached the second region, photographing of the object is performed based on the reflected photographing setting.

6. The image pickup apparatus according to claim 4, wherein
the at least one processor and/or circuit are configured to further function as a unit that adds information to a frame-based image that has been outputted by the image pickup unit at a timing of a photographing instruction that has been received from a user during the photographing.

7. The image pickup apparatus according to claim 5, wherein
the at least one processor and/or circuit are configured to further function as a unit that adds information to a frame-based image that has been outputted by the image pickup unit at a timing of a photographing instruction that has been received from a user during the photographing.

8. The image pickup apparatus according to claim 1, wherein
the photographing setting includes a shutter speed, an ISO sensitivity, and an aperture stopping amount.

9. The image pickup apparatus according to claim 1, wherein
the extracting unit sets a region composed of pixels with luminance values equal to or less than a first threshold value for extracting a blocked-up shadow region as the first region, and sets a region composed of pixels with luminance values higher than the first threshold value as the second region.

10. The image pickup apparatus according to claim 1, wherein
the extracting unit sets a region composed of pixels with luminance values equal to or greater than a second threshold value for extracting a blown-out highlight region as the first region, and sets a region composed of pixels with luminance values lower than the second threshold value as the second region.

11. A control method for an image pickup apparatus, the control method comprising:
an image pickup step of causing an image pickup unit of the image pickup apparatus to output a frame-based image;
an extracting step of extracting, from the frame-based image, a first region whose brightness is outside a dynamic range of the image pickup unit and a second region other than the first region;
an obtaining step of obtaining event signals, each of which indicates a position and a time, at which a change in luminance has occurred, in an angle of view, at which the image pickup apparatus performs photographing;
a recognizing step of recognizing an object in the angle of view based on the event signals;
a movement vector calculating step of calculating a movement vector of the object;
a photographing setting calculating step of calculating a photographing setting of the image pickup unit based on the movement vector; and
a step of reflecting the photographing setting at a predetermined timing related to movement of the object from the first region to the second region.

12. A non-transitory computer-readable storage medium storing a program for causing a computer to execute a control method for an image pickup apparatus, the control method comprising:
an image pickup step of causing an image pickup unit of the image pickup apparatus to output a frame-based image;
an extracting step of extracting, from the frame-based image, a first region whose brightness is outside a dynamic range of the image pickup unit and a second region other than the first region;
an obtaining step of obtaining event signals, each of which indicates a position and a time, at which a change in luminance has occurred, in an angle of view, at which the image pickup apparatus performs photographing;
a recognizing step of recognizing an object in the angle of view based on the event signals;
a movement vector calculating step of calculating a movement vector of the object;
a photographing setting calculating step of calculating a photographing setting of the image pickup unit based on the movement vector; and
a step of reflecting the photographing setting at a predetermined timing related to movement of the object from the first region to the second region.
